(19) United States
(12) Patent Application Publication
(10) Pub. No.: US 2010/0195543 A1
(43) Pub. Date: Aug. 5, 2010

(54) APPARATUS AND METHOD FOR INTERFERENCE CANCELLATION IN MOBILE FULL DUPLEX RELAY

(75) Inventors: Sung-Yoon JUNG, Seoul (KR); Seung-Hee Han, Hwaseong-si (KR); Tak-Ki Yu, Yongin-si (KR); Sang-Boh Yun, Seongnam-si (KR); Sung-Hwan Kim, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/699,515

(22) Filed: Feb. 3, 2010

(30) Foreign Application Priority Data
Feb. 3, 2009 (KR) 10-2009-0008284

(51) Int. Cl. H04B 7/14

(52) U.S. Cl. 370/279

(57) ABSTRACT

A method and an apparatus for canceling an interference in a mobile Full Duplex Relay (FDR) are provided. A signal is received from a base station, interference canceling that uses a transmitter interference signal from which an original signal interference has been cancelled is repeatedly performed on the signal received from the base station, and an interference-cancelled signal is transmitted.

### PRIORITY

This application claims priority under 35 U.S.C. §119(a) to a Korean patent application filed in the Korean Intellectual Property Office on Feb. 3, 2009 and assigned Serial No. 10-2009-0008284, the entire disclosure of which is hereby incorporated by reference.

### BACKGROUND OF THE INVENTION

1. Field of the Invention

The present invention relates to an apparatus and a method for estimating and canceling an interference channel in a mobile Full Duplex Relay (FDR).

2. Description of the Related Art

A multi-hop transmission technique using a wireless relay in a wireless communication system is a wireless communication method where one or more relays receive and transfer data in a serial manner between a transmitter and a receiver.

When the multi-hop transmission is used, a service may be effectively provided to users in a cell boundary area or a shadow area where a channel environment is poor.

In general, it is difficult for a relay to perform transmission and reception using the same frequency resource at the same time due to an interference problem generated in a reception signal by a transmission signal.

The simplest and conventional method for resolving this problem is to allow a relay to use different wireless resources for reception and transmission. However, since this method limits wireless resources that the relay may use for transmission, this method results in a deterioration of a system capacity.

To address this problem, a technique for increasing a transmission capacity of a relay by applying an interference cancellation function to the relay and thus allowing the relay to perform transmission/reception using the same wireless resource is considered, and a Full Duplex Relay (FDR) for performing this function has been suggested.

The FDR uses an interference cancellation technique in order to cancel interference caused to a receiver side by a transmission signal of a transmitter. For canceling interference, an interference channel of a transmitter needs to be estimated.

In the case of estimating a transmission signal, the FDR assumes that an interference signal of a transmitter is remarkably greater than a signal of a receiver, ignores an influence of the receiver signal because the receiver signal is relatively small in size, and performs channel estimation on an interference channel of the transmitter. To perform the channel estimation, the FDR needs to use pilot signals.

Since the FDR can identify all signals to be transmitted, all transmission signals may be used as pilot signals for channel estimation.

In the case where the FDR is fixed, an interference channel of the transmitter is almost constant, a desired performance may be determined without any enhancement of the interference channel estimation and a cancellation technique.

However, in more recent mobile communication systems, use of a mobile relay at a moving network is being realized and a time variance of an interference channel of a transmitter is increased by the movement of a relay, which requires an enhancement of the interference channel estimation and a cancellation technique.

### SUMMARY OF THE INVENTION

The present invention has been designed to address at least the problems and/or disadvantages described above and to provide at least the advantages described below.

Accordingly, an aspect of the present invention is to provide an apparatus and a method for canceling an interference in a mobile Full Duplex Relay (FDR).

Another aspect of the present invention is to provide an apparatus and a method for estimating and canceling an interference channel in the case where time variance of an interference channel of a transmitter increases in a mobile FDR.

In accordance with an aspect of the present invention, a method for canceling an interference in a mobile FDR is provided. The method includes receiving a signal from a base station, repeatedly performing interference canceling that uses a transmitter interference signal from which an original signal interference has been cancelled on the signal received from the base station, and transmitting an interference-cancelled signal.

In accordance with another aspect of the present invention, an apparatus of a mobile FDR for canceling an interference is provided. The apparatus includes a reception modem for receiving a signal from a base station, an interference channel estimation and control unit for repeatedly performing interference canceling that uses a transmitter interference signal from which an original signal interference has been cancelled on the signal received from the base station, and a transmission modem for transmitting an interference-cancelled signal.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a block diagram illustrating an FDR according to an embodiment of the present invention; and

FIG. 2 is a flowchart illustrating a procedure for canceling an interference in an FDR according to an embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of embodiments of the invention as defined by the claims and their equivalents. The following description includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to their dictionary meanings, but, are merely used by the inventor to enable a clear and consistent understanding of the invention. Accordingly, it should be apparent to those skilled in the art that the following description of embodiments of the present invention are provided for illustration purpose only and not for the purpose of limiting the invention as defined by the appended claims and their equivalents.

Embodiments of the present invention provide an apparatus and a method for canceling an interference in a mobile FDR.

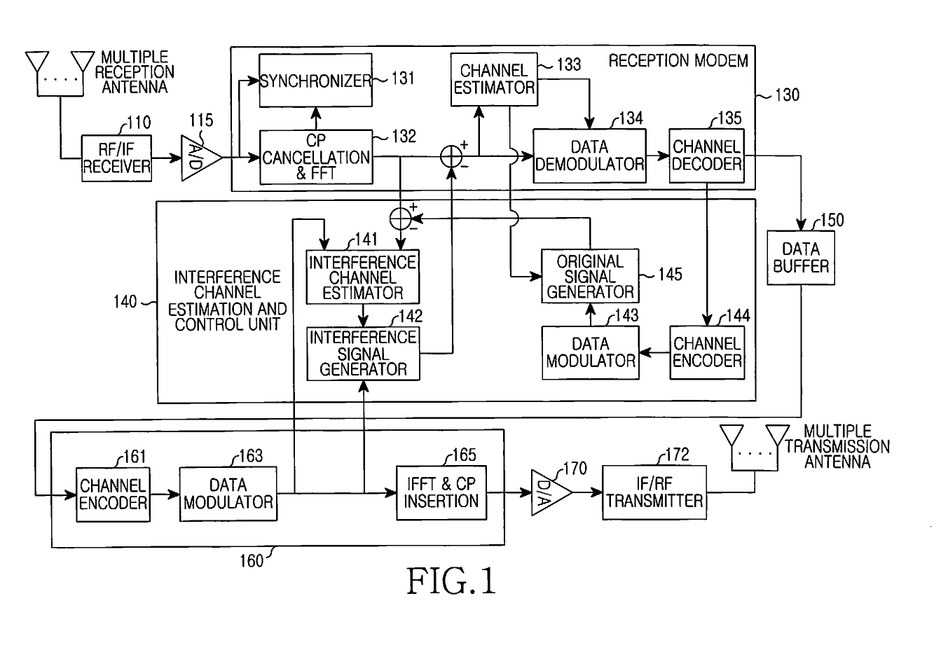

FIG. 1 is a block diagram illustrating an FDR according to an embodiment of the present invention.

Referring to FIG. 1, the FDR includes a reception modem 130, a transmission modem 160, an interference channel estimation and control unit 140, a Radio Frequency (RF) circuit (which includes an RF/Intermediate Frequency (IF) receiver 110 and an IF/RF transmitter 172) for transmitting/receiving a signal to/from the transmission modem 160 or the reception modem 130, a data buffer 150 for temporarily storing data to be transmitted, an Analog Digital (A/D) converter 115, a Digital Analog (D/A) converter 170, and multiple transmission and reception antennas.

The reception modem 130 demodulates and decodes a reception signal that is received from a base station, and that passes through the multiple reception antenna and the RF/IF receiver 110 and is A/D-converted in the A/D converter 115, and transfers the reception signal to the data buffer 150.

During this process, a frequency synchronization process at a synchronizer 131, and Cyclic Prefix (CP) cancellation and Fast Fourier Transform (i) used for Orthogonal Frequency Division Multiplexing (OFDM) at a CP cancellation & FFT unit 132 are performed. A signal where a CP has been cancelled and FFT has been completed is provided to an interference channel estimator 141 of the interference channel estimation and control unit 140.

The reception modem 130 cancels an interference signal from a signal where a CP has been cancelled and FFT has been completed using an interference signal estimation value provided from an interference signal generator 142 of the interference channel estimation and control unit 140, and provides the signal to a channel estimator 133 and a data demodulator 134.

The channel estimator 133 performs channel estimation on a signal from which an interference signal has been cancelled. A demodulation process at the data demodulator 134 and a data decoding process at the channel decoder 135 are performed on a channel estimation value, that is, a channel-estimated signal. A signal that has been completely decoded is stored in the data buffer 150.

The channel estimator 133 provides an original signal for which channel estimation has been completed to an original signal generator 145 of the interference channel estimation and control unit 140.

In addition, the channel decoder 135 provides data that has been completely decoded to a channel encoder 144 of the interference channel estimation and control unit 140. The channel encoder 144 performs an encoding process on a received signal, and a data modulator 143 modulates an encoded signal to provide the same to the original signal generator 145.

That is, the reception modem 130 cancels an interference signal from a receiver baseband signal (a signal where a CP has been cancelled and FFT has been completely performed) including an interference signal and a transmitter original signal, demodulates and decodes the original signal, and stores the signal in the data buffer 150. During this process, the original signal is provided to the original signal generator 145.

The reception modem 130 cancels an interference signal from a reception signal using the interference signal estimation value, and then performs data demodulation and decoding. An interference cancellation process using a reception signal and an output of the interference channel estimation and control unit 140 is repeatedly performed until a desired number of repetition arrives, and then a final transmission signal is generated.

The reception modem 130 performs interference cancellation by canceling an interference signal for each subcarrier.

The channel encoder 144 of the interference channel estimation and control unit 140 receives an original signal-decoded signal on a subcarrier basis from the channel decoder 135 of the reception modem 130.

The original signal generator 145 of the interference channel estimation and control unit 140 receives an original signal (a signal from which an interference has been cancelled) on a subcarrier basis from the channel estimator 133 of the reception modem 130.

In addition, the interference channel estimator 141 of the interference channel estimation and control unit 140 receives a signal from which an original signal has been cancelled from a reception signal where a transmitter interference signal coexists on a subcarrier basis from the CP cancellation & FFT unit 132 of the reception modem 130.

The original signal cancellation process is performed by canceling an original signal provided by the original signal generator 145 from the reception signal where a transmitter interference signal coexists.

Since an original signal acts as an interference while the interference channel estimator 141 estimates a transmitter interference signal using a reception signal, the interference channel estimator 141 estimates an interference channel with respect to a signal from which an interference has been cancelled using an original signal-decoded signal.

The interference channel estimator 141 generates an estimation value of an interference channel for each subcarrier using an interference channel estimation value and a transmission signal for each subcarrier provided from the transmission modem 160, and provides the generated estimated value to the interference signal generator 142.

The interference signal generator 142 generates an interference signal estimation value using an interference channel estimation value and a transmission signal provided by the transmission modem 160, and provides the generated interference signal estimation value to the reception modem 130.

The transmission modem 160 performs encoding at the channel encoder 161 and modulation at the data modulator 163 on data from the data buffer 150 to generate a transmission signal, and performs OFDM modulation at an IFFT & CP insertion unit 165.

A signal on which the OFDM modulation has been performed is provided to the D/A converter 170, where digital-to-analog conversion of the signal is performed, and then is transmitted via the IF/RF transmitter 172.

In the above-described FDR, though now shown, a controller may perform a function of the interference channel estimation and control unit 140. Separate configuration and illustration of the interference channel estimation and control unit 140 in an embodiment of the present invention is for separately describing each function, which may be performed by the controller.

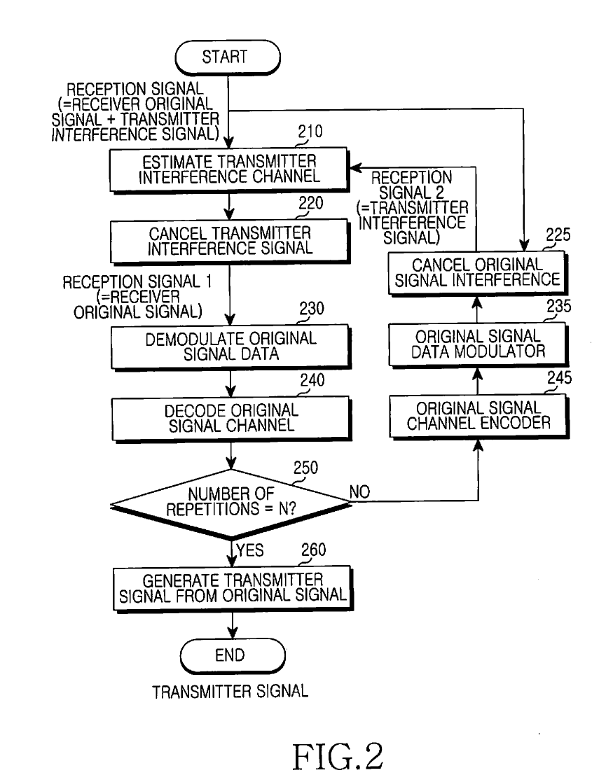

FIG. 2 is a flowchart illustrating a procedure for canceling an interference in an FDR according to an embodiment of the present invention.

Referring to FIG. 2, the interference channel estimation and control unit receives from the reception modem a transmitter signal where a transmitter original signal and a transmitter interference signal coexist when the number of repetition is 1, or a receiver signal where a receiver original signal has been cancelled to some extent when the number of repetition is 2 or more.

The interference channel estimation and control unit performs transmitter channel estimation using the reception signal in step 210, and performs transmitter interference signal cancellation using the estimated interference channel estimation value in step 220 to generate a reception signal 1 from which transmitter interference has been cancelled, at least to some extent.

The interference channel estimation and control unit performs original signal data demodulation on the reception signal 1 in step 230, and performs channel-decoding on the reception signal 1 in step 240.

When the number of repetition equals N in step 250, the interference channel estimation and control unit generates a transmitter signal in step 260.

When the number of repetition is not equal to N in step 250, the interference channel estimation and control unit again performs encoding on the decoded original signal in step 245, and performs modulation on the decoded original signal in step 235 to generate an original signal.

The interference channel estimation and control unit performs original signal interference cancellation using the generated original signal in step 225 to generate a reception signal 2 from which original signal interference has been cancelled, at least to some extent, and uses the reception signal 2 as an input of the interference channel estimation and control unit.

A high performance can be achieved using the above-described repetitive method even when an amount of change in a transmitter interference channel is great and, in addition, an interference signal size is limited.

Embodiments of the present invention provide an advantage of raising interference channel estimation and cancellation performance by repeatedly performing, at a mobile FDR, transmitter interference channel estimation and cancellation, and original signal estimation and cancellation.

Embodiments of the present invention may support a relay that uses an FDR even under a mobile network environment by improving performance using the above-described repetitive method even in the case where an amount of change in a transmitter interference channel is great or an interference signal size is limited in a mobile FDR.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for canceling interference in a mobile Full Duplex Relay (FDR), the method comprising the steps of:
receiving, by a reception modem, a signal from a base station;
repeatedly performing on the signal received from the base station, by an interference channel estimation and control unit, interference canceling that uses a transmitter interference signal from which an original signal interference has been cancelled; and
transmitting, by a transmission modem, an interference-cancelled signal.

2. The method of claim 1, wherein the signal received from the base station includes a signal where a receiver original signal and a transmitter interference signal coexist.

3. The method of claim 1, wherein repeatedly performing the interference canceling comprises:
performing, by the interference channel estimation and control unit, channel estimation on a transmitter interference signal; and
generating, by the interference channel estimation and control unit, a first reception signal by performing transmitter interference cancellation on the signal received from the base station using a channel estimation value for the transmitter interference signal.

4. The method of claim 3, wherein repeatedly performing the interference canceling further comprises:
performing, by the interference channel estimation and control unit, data demodulation and channel-decoding on the first reception signal;
generating, by the interference channel estimation and control unit, an original signal by performing channel-encoding and data modulation on the channel-decoded signal;
canceling, by the interference channel estimation and control unit, an original signal interference from the first reception signal using the generated original signal;
generating, by the interference channel estimation and control unit, a second reception signal by performing data demodulation and channel encoding on the signal from which the original signal interference has been cancelled; and
repeating N times, by the interference channel estimation and control unit, the generating of the first reception signal and the second reception signal.

5. The method of claim 4, wherein transmitting the interference-cancelled signal comprises:
storing the second reception signal in a buffer; and
performing, by the transmission modem, channel-encoding and data modulation on the second reception signal stored in the buffer to transmit the same.

6. An apparatus of a mobile Full Duplex Relay (FDR) for canceling an interference, the apparatus comprising:
a reception modem for receiving a signal from a base station;
an interference channel estimation and control unit for repeatedly performing on the signal received from the base station interference canceling that uses a transmitter interference signal from which an original signal interference has been cancelled; and
a transmission modem for transmitting an interference-cancelled signal.

7. The apparatus of claim 6, wherein the signal received from the base station includes a signal where a receiver original signal and a transmitter interference signal coexist.

8. The apparatus of claim 6, wherein the interference channel estimation and control unit performs channel estimation on a transmitter interference signal, and generates a first reception signal by performing transmitter interference cancellation on the signal received from the base station using a channel estimation value for the transmitter interference signal.

9. The apparatus of claim 8, wherein the interference channel estimation and control unit performs data demodulation and channel-decoding on the first reception signal, generates an original signal by performing channel-encoding and data modulation on the channel-decoded signal, cancels an original signal interference from the first reception signal using the generated original signal, generates a second reception signal by performing data demodulation and channel encoding on the signal from which the original signal interference has been cancelled, and repeats N times the generating of the first reception signal and the second reception signal.

10. The apparatus of claim 9, wherein the transmission modem stores the second reception signal in a buffer, and performs channel-encoding and data modulation on the second reception signal stored in the buffer to transmit the same.
